(19) United States
(12) Patent Application Publication
(10) Pub. No.: US 2018/0165307 A1
(43) Pub. Date: Jun. 14, 2018

(54) Executing Queries Referencing Data Stored in a Unified Data Layer

(71) Applicant: International Business Machines Corporation, Armonk, NY (US)

(72) Inventors: Paul M. Cadarette, Hemet, CA (US); Anjan G. Lukkoor, Saratoga, CA (US); James D. Spyker, Toronto (CA)

(21) Appl. No.: 15/881,989

(22) Filed: Jan. 29, 2018

Related U.S. Application Data
(63) Continuation of application No. 15/373,978, filed on Dec. 9, 2016.

(51) Int. Cl. G06F 17/30

(52) U.S. Cl. CPC G06F 17/30292; G06F 17/30607; G06F 17/30566; G06F 17/30554; G06F 17/30477

(57) ABSTRACT

A mechanism is provided in a data processing system for executing queries referencing data stored in a unified data layer. A relational engine executing on the data processing system receives a structured query language (SQL) query from a client. A query processor executing on the data processing system accesses integrated data sources including a unified data layer (UDL) data source storing UDL topic files via a data virtualization layer to form query results. The data virtualization layer projects the UDL topic files into relational form. The relational engine returns the query results to the client.

### BACKGROUND

The present application relates generally to an improved data processing apparatus and method and more specifically to mechanisms for executing queries referencing data stored in a unified data layer.

An operational data store (ODS) is a database designed to integrate data from multiple sources for additional operations on the data. Unlike a master data store, the data are not passed back to operational systems. It may be passed for further operations and to the data warehouse for reporting.

Because the data originate from multiple sources, the integration often involves cleaning, resolving redundancy, and checking against business rules for integrity. An ODS is typically designed to contain tow-level or atomic (indivisible) data (such as transactions and prices) with limited history that is captured “real time” or “near real time” as opposed to the much greater volumes of data stored in the data warehouse generally on a less-frequent basis.

The general purpose of an ODS is to integrate data from disparate source systems in a single structure, using data integration technologies like data virtualization, data federation, or extract, transform, and load. This allows operational access to the data for operational reporting, master data, or reference data management.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided in a data processing system for executing queries referencing data stored in a unified data layer. The method comprises receiving, by a relational engine executing on the data processing system, a structured query language (SQL) query from a client. The method further comprises accessing, by a query processor executing on the data processing system, integrated data sources including a unified data layer (UDL) data source storing UDL topic files via a data virtualization layer to form query results. The data virtualization layer projects the UDL, topic files into relational form. The method further comprises returning, by the relational engine, the query results to the client.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system in which aspects of the illustrative embodiments may be implemented;

FIG. 2 is an example block diagram of a computing device in which aspects of the illustrative embodiments may be implemented;

FIG. 3 is a block diagram depicting a server image with a relational engine that supports data source extensions and provides a virtualization layer extension specific to a unified data layer in accordance with an illustrative embodiment;

FIGS. 4A and 4B illustrate a SQL engine accessing unified data layer files in accordance with the illustrative embodiments;

FIG. 5 depicts a standard analytics use case for UDL;

FIG. 6 depicts a standard analytics use case for UDL in accordance with the illustrative embodiment;

FIG. 7 depicts a generic use case that enables any JDBC/SQL-based tooling or application to access UDL data in accordance with the illustrative embodiment; and

FIG. 8 is a flowchart illustrating operation of a mechanism for executing queries referencing data stored in a unified data layer in accordance with an illustrative embodiment.

### DETAILED DESCRIPTION

The standard use case for a Unified Data Layer (UDL) is as a source of data to be moved to analytics platforms such as data warehouses and Hadoop environments. Apache Hadoop™ is an open-source software framework for distributed storage and distributed processing of very large data sets on computer clusters built from commodity hardware. The core of Apache Hadoop™ consists of a storage part, known as Hadoop™ Distributed File System (HDFS), and a processing part called MapReduce. Hadoop™ splits files into large blocks and distributes them across nodes in a cluster,

Apache Spark™ is an open-source cluster computing framework. Apache Spark™ provides programmers with an application programming interface centered on a data structure called the resilient distributed dataset (RDD), a read-only multiset of data items distributed over a cluster of machines, which is maintained in a fault-tolerant way. It was developed in response to limitations in the MapReduce cluster computing paradigm, which forces a particular linear dataflow structure on distributed programs: MapReduce programs read input data from disk, map a function across the data, reduce the results of the map, and store reduction results on disk. Spark's RDDs function as a working set for distributed programs that offers a restricted form of distributed shared memory.

Apache Parquet™ is a free and open-source column-oriented data store of the Apache Hadoop™ ecosystem. Apache Parquet is compatible with most of the data processing frameworks in the Hadoop™ environment. It provides efficient data compression and encoding schemes with enhanced performance to handle complex data in bulk.

Apache Avro™ is a remote procedure call and data serialization framework developed within the Apache Hadoop™ project. Apache Avro™ uses JavaScript Object Notation (JSON) for defining data types and protocols, and serializes data in a compact binary format. Its primary use is in Apache Hadoop™, where it can provide both a serialization format for persistent data, and a wire format for communication between Hadoop™ nodes, and from client programs to the Hadoop™ services.

The Unified Data Layer typically contains what is the logical equivalent of an Operational Data Store (PDS) in the Confluent Platform, whose data happens to reside in Kafka topics. Apache Kafka™ is an open-source stream processing platform developed by the Apache Software Foundation written in the Scala and Java™ programming languages. Apache Kalka™ provides a unified, high-throughput, low-latency platform for handling real-time data feeds. Its storage layer is, in its essence, a “massively scalable pub/sub message queue architected as a distributed transaction log,” making it highly valuable for enterprise infrastructures to process streaming data.

Analytics are not done directly against the data stored in the Confluent Platform, which is additional tooling on top of Kafka™. The Confluent Platform provides a generic schema description using, for example, JavaScript Object Notation (JSON), to provide an open-standard format using human-readable text to transmit data objects consisting of attribute-value pairs. Instead, that data must first be ingested into an analytics store (e.g., HDFS for Apache Hadoop™ or Apache Spark's™, RDDs for Spark™, etc.), from the Confluent Platform, before heavy analytics can be executed.

Some analytics can be done directly against the data in the Confluent Platform by writing a custom program to scan through the data, but that is impractical for data scientists.

The illustrative embodiments provide the ability to use conventional Structured Query Language (SQL) to formulate queries that can be executed directly against the data residing in Confluent. Such an approach would allow for some direct analytics, using SQL, as well as intelligent sub-setting queries that reduce the amount of data that must be pulled into the memory constructs (e.g., RDDs), or persistence mechanisms (e.g., Parquet, HDFS, etc.) of heavier analytics tooling.

Before beginning the discussion of the various aspects of the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a,” “at least one of,” and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular implementation for accomplishing and/or performing the actions, steps, processes, etc., attributable to and/or performed by the engine. An engine may be, but is not limited to, software, hardware and/or firmware or any combination thereof that performs the specified functions including, but not limited to, any use of a general and/or specialized processor in combination with appropriate software loaded or stored in a machine readable memory and executed by the processor. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

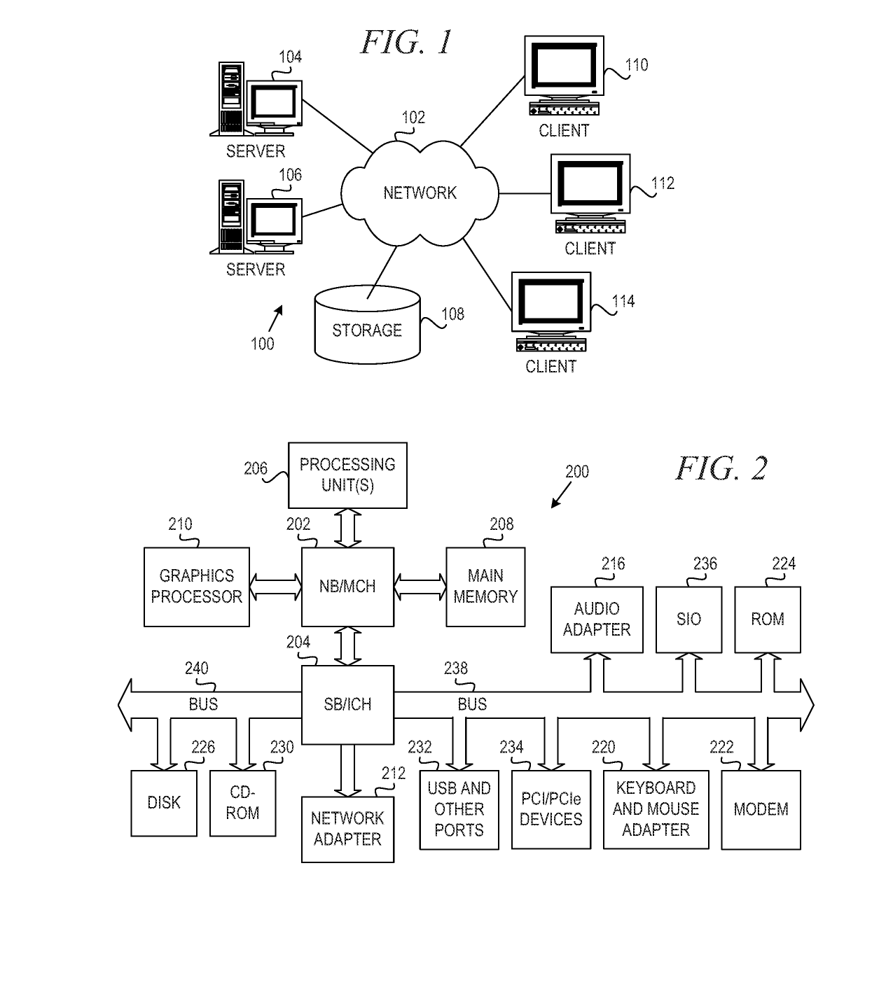

The illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet. Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

As shown in FIG. 1, one or more of the computing devices, e.g., server 104, may be specifically configured to implement a relational engine for executing queries referencing data stored in a unified data layer. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates executing queries referencing data stored in a unified data layer.

The basic architecture described herein has similarities to that of existing federation/virtualization technologies. A conventional SQL execution engine is used as an interface with the user. The SQL statements are parsed and a data access plan specific to this architecture is created. An underlying abstraction layer allows for plug-ins that support alternative data sources.

In accordance with the illustrative embodiments, that data source would be UDL data, stored in Kafka™ topics for example. An abstraction layer implementation allows for the direct mapping of UDL: topics, bypassing queueing protocols, that reside in Kafka™/UDL topic files, with automatic schema projection using the Confluent Schema registry as a reference.

The illustrative embodiments enable direct relational access, including horizontal and vertical sub-setting, to Kafka™/UDL data from any application that uses standard Java™ Database Connectivity (JDBC) or Open Database Connectivity (ODBC) tooling. Additionally, the illustrative embodiments allow for lightweight analytics using the power of SQL and a smaller, targeted movement of data into analytics engines for heavy-duty calculations. Thus, the illustrative embodiments use UDL/Kafka™ topic files as an integrated data-source for a relational SQL front-end and the methodology used to access/project UDL/Kafka™ topic data as relational data.

As noted above, the mechanisms of the illustrative embodiments utilize specifically configured computing devices, or data processing systems, to perform the operations for executing SQL-based queries referencing data stored in a unified data layer. These computing devices, or data processing systems, may comprise various hardware elements which are specifically configured, either through hardware configuration, software configuration, or a combination of hardware and software configuration, to implement one or more of the systems/subsystems described herein. FIG. 2 is a block diagram of just one example data processing system in which aspects of the illustrative embodiments may be implemented. Data processing system 200 is an example of a computer, such as server 104 in FIG. 1, in which computer usable code or instructions implementing the processes and aspects of the illustrative embodiments of the present invention may be located and/or executed so as to achieve the operation, output, and external affects of the illustrative embodiments as described herein.

In the depicted example, data processing system 200 employs a hub architecture including north bridge and memory controller hub (NB/MCH) 202 and south bridge and input/output (I/O) controller huh (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect, to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows 7®. An object-oriented programming system, such as the Java™ programming system, may run in conjunction with the operating system and provides calls to the operating system from Java™ programs or applications executing on data processing system 200.

As a server, data processing system 200 may be, for example, an IBM eServer™ System p® eServer computer system, Power™ processor based computer system, or the like, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modern 222 or network adapter 212 of FIG. 2, may include one or more devices used to transmit and receive data. A memory may be, for example, main memory 208, ROM 224, or a cache such as found in NB/MCH 202 in FIG. 2.

As mentioned above, in some illustrative embodiments the mechanisms of the illustrative embodiments may he implemented as application specific hardware, firmware, or the like, application software stored in a storage device, such as HDD 226 and loaded into memory, such as main memory 208, for executed by one or more hardware processors, such as processing unit 206, or the like. As such, the computing device shown in FIG. 2 becomes specifically configured to implement the mechanisms of the illustrative embodiments and specifically configured to perform the operations and generate the outputs described hereafter with regard to the relational engine for executing SQL-based queries referencing data stored in a unified data layer.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

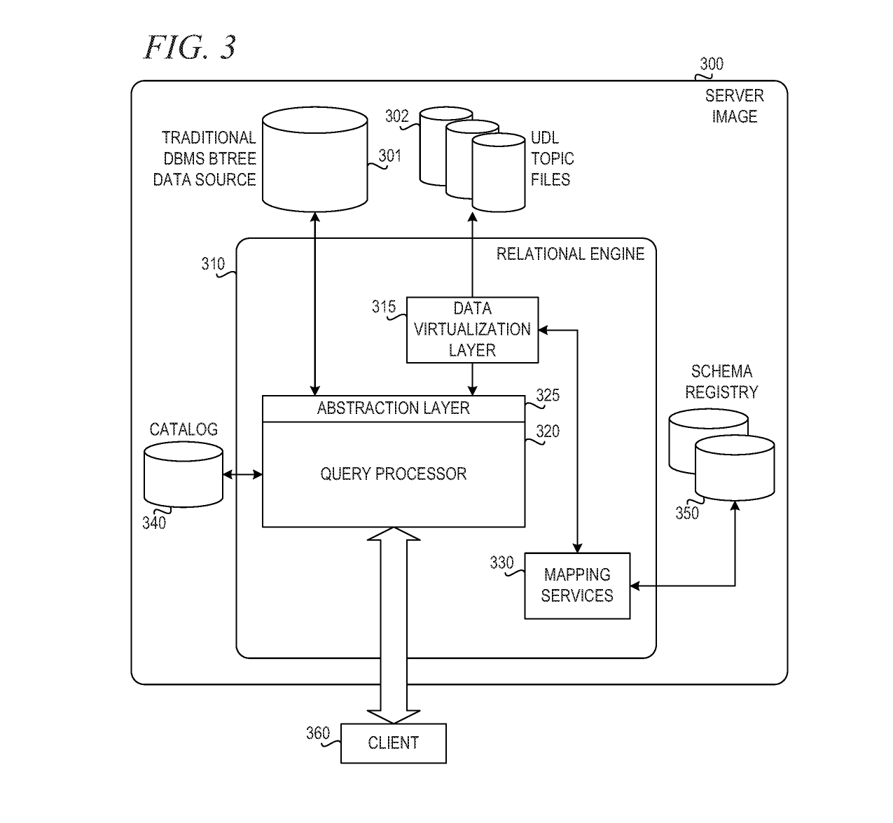

FIG. 3 is a block diagram depicting a server image with a relational engine that supports data source extensions and provides a virtualization layer extension specific to a unified data layer in accordance with an illustrative embodiment. Server image 300 includes a relational engine 310 that allows client 360 to access traditional database management system (DBMS) B-tree data source 301 and unified data layer (UDL) files 302. Relational engine 310 includes query processor 320 having an abstraction layer 325, which allows for plug-ins that support alternative data sources.

In accordance with an illustrative embodiment, a virtualization layer 315 is provided for projecting UDL topic data 302 as relational data. For the purposes of this description, the virtualization layer is referred to as the Data Virtualization Layer (DVL) 315. The DVL 315 interfaces with the schema registry 350 (e.g., Confluent schema registry), Confluent application programming interfaces (APIs) (not shown), and standard file APIs (not shown) to directly access unified data layer (UDL) files 302. Mapping services 330 uses schema information from registry 350 for a given topic and automatically maps the topic into relational form, effectively creating a virtual table from a catalog 340 perspective.

Query processor 320 performs access directly against the UDL topic files 302. The topic file has a public layout for direct access via indices or by scanning the contents. Mapping services projects the data payload in each topic message into relational form using Avro™/JSON schema and based on the particular SQL execution plan received by query processor 320, which returns the result set to client 360 (e.g., JDBC, ODBC, command-line interface, etc.) as if the query had been executed against an actual relational table.

Standard Database techniques, such as block reads and parallel processing (at a topic level or below) should result in an operational profile superior to the traditional get/put APIs for queuing. The DVL maintains positioning for all returned result sets, such that old results for any key value can be discarded. Kafka™ partitioning will be transparent to this access approach. Successive queries would reflect the changing native of UDL/Kafka™ contents as messages are added. Additional operations such as garbage collection and log compaction will result in changed (but accurate) results on any given query.

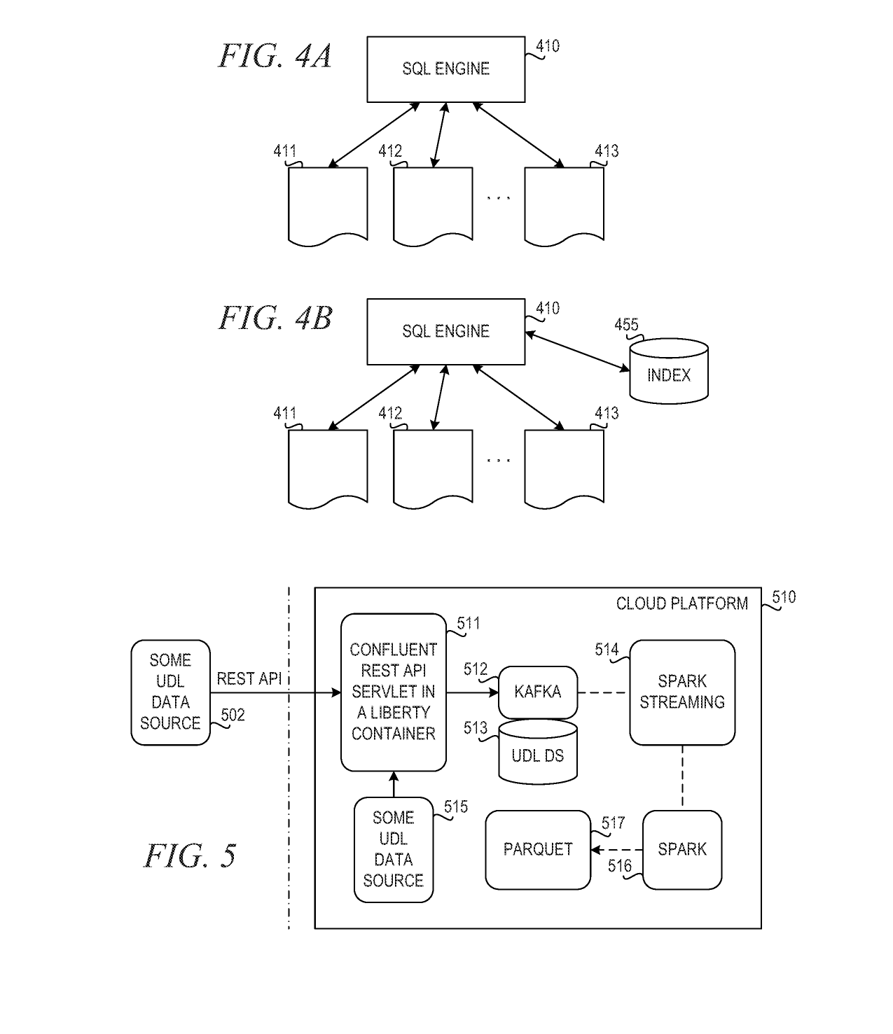

FIGS. 4A and 4B illustrate a SQL engine accessing unified data layer files in accordance with the illustrative embodiments. In FIG. 4A, SQL engine 410 access UDL files by scanning the contents of UDL files 411-413. In this example, SQL engine 410 requests results from each file using SQL-subsetting.

Turning to FIG. 4B, SQL engine 410 accesses UDL files 411-413 by SQL index 455. In this example, SQL engine 410 uses index 455 to determine if there are any files that need not be included because they have not data of interest.

FIG. 5 depicts a standard analytics use case for UDL. Cloud platform 510 includes a Confluent Representational State Transfer (REST) API servlet 511. In one embodiment, cloud platform 510 may be implemented as the IBM Bluemix™ is a cloud platform as a service (PaaS) developed by International Business Machines Corporation. Servlet 511 accesses data from some UDL data source 502 through the REST API. Servlet 511 also accesses data from some UDL data source 515. Apache Kafka™ 512 stores the data in UDL data store (DS) 513.

In the example depicted in FIG. 5, Apache Spark™ streaming component 514 accesses the UDL data through Apache Kafka™ 512 and streams the data to Apache Spark™ component 516. The Apache Spark™ component 516 provides the data to Apache Parquet™ component 517.

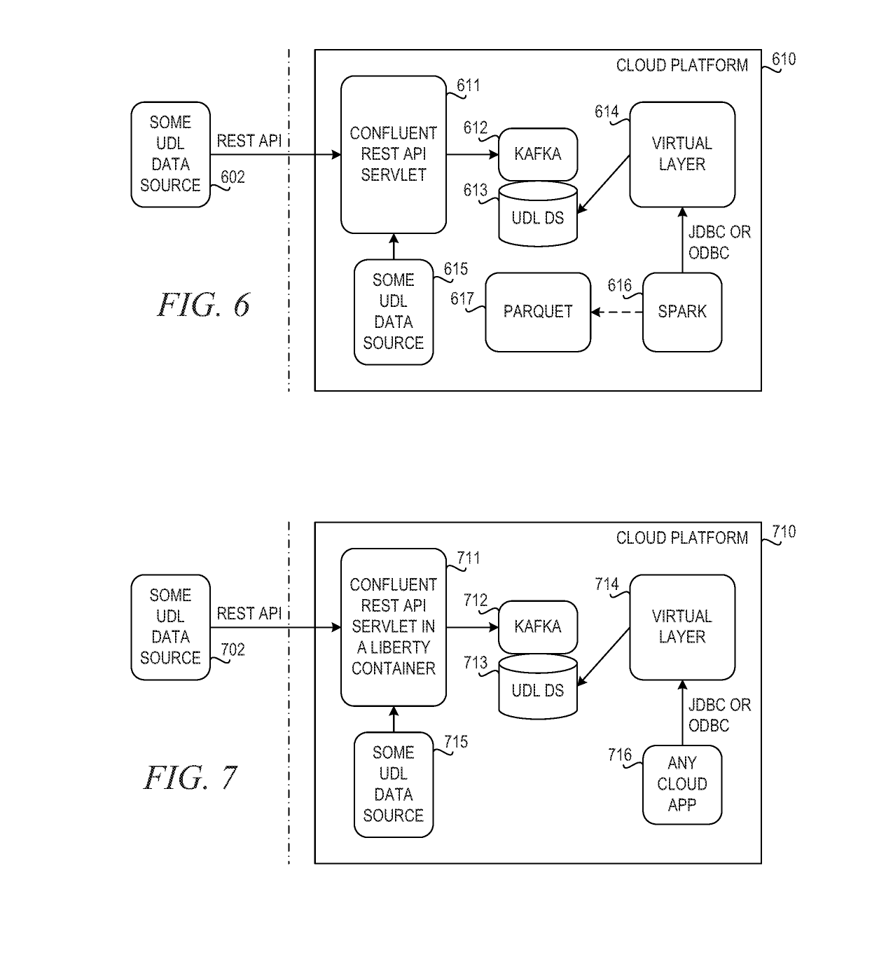

FIG. 6 depicts a standard analytics use case for UDL in accordance with the illustrative embodiment. Cloud platform 610 includes a Confluent Representational State Transfer (REST) API servlet 611. In one embodiment, cloud platform 610 may be implemented as the IBM Bluemix™ is a cloud platform as a service (PaaS) developed by International Business Machines Corporation. Servlet 611 accesses data from some UDL data source 602 through the REST API, Servlet. 611 also accesses data from some UDL data source 615. Apache Kafka™ 612 stores the data in UDL data store (DS) 613.

In accordance with the illustrative embodiment, virtualization layer 614 accesses the UDL data from UDL DS 613 directly. Any cloud application 716 can then access the UDL data through virtualization layer 614. Apache Spark™ component 616. The Apache Spark™ component 616 provides the data to Apache Parquet™ component 617.

FIG. 7 depicts a generic use case that enables any JDBC/SQL-based tooling or application to access UDL data in accordance with the illustrative embodiment. Cloud platform 710 includes a Confluent Representational State Transfer (REST) API servlet 711. In one embodiment, cloud platform 710 may be implemented as the IBM Bluemix™ is a cloud platform as a service (PaaS) developed by International Business Machines Corporation. Servlet 711 accesses data from some UDL data source 702 through the REST API. Servlet 711 also accesses data from some UDL, data source 715. Apache Kafka™ 712 stores the data in UDL data store (DS) 713.

In accordance with the illustrative embodiment, virtualization layer 714 accesses the UDL data from UDL DS 713 directly. Any cloud application 716 can then access the UDL data through virtualization layer 714.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider), in some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

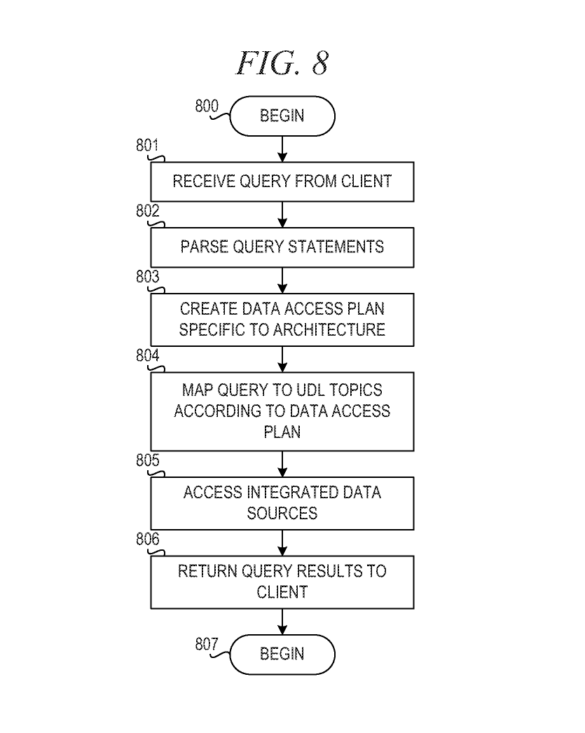

FIG. 8 is a flowchart illustrating operation of a mechanism for executing queries referencing data stored in a unified data layer in accordance with an illustrative embodiment. Operation begins (block 800), and the mechanism receives a structured query language (SQL) query from a client (block 801). The mechanism parses the query statements (block 802) and creates a data access plan specific to the architecture (block 803).

A data virtualization layer projects UDL topic files into relational form using a schema registry as a reference. The mechanism then maps the query to unified data layer (UDL) topics according to the data access plan (block 804). The mechanism accesses the integrated data sources (block 805). The data virtualization layer enables direct relational access, including horizontal and vertical sub-setting, to UDL data from any application that uses standard JDBC or ODBC tooling. The mechanism returns the query results to the client (block 806). Thereafter, operation ends (block 807).

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Thus, the illustrative embodiments provide mechanisms for using UDL/Kafka™ topic files as an integrated data source for a relational SQL front end and the methodology used to access/project UDL/Kafka™ topic data as relational data. The mechanisms of the illustrative embodiments allow for lightweight analytics using the power of SQL and a smaller, targeted movement of data into analytics engines for heavy duty calculations.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a communication bus, such as a system bus, for example. The memory elements can include local memory employed during actual execution of the program code, bulk storage, and cache memories which provide temporary storage of at least some program code in order to reduce the number of times code must be retrieved from bulk storage during execution. The memory may be of various types including, but not limited to, ROM, PROM, EPROM, EEPROM, DRAM, SRAM, Flash memory, solid state memory, and the like.

Input/output or I/O devices (including but not limited to keyboards, displays, pointing devices, etc.) can be coupled to the system either directly or through intervening wired or wireless I/O interfaces and/or controllers, or the like. I/O devices may take many different forms other than conventional keyboards, displays, pointing devices, and the like, such as for example communication devices coupled through wired or wireless connections including, but not limited to, smart phones, tablet computers, touch screen devices, voice recognition devices, and the like. Any known or later developed I/O device is intended to be within the scope of the illustrative embodiments.

Network adapters may also be coupled to the system to enable the data processing system to become coupled to other data processing systems or remote printers or storage devices through intervening private or public networks. Modems, cable modems and Ethernet cards are just a few of the currently available types of network adapters for wired communications. Wireless communication based network adapters may also be utilized including, but not limited to, 802.11 a/b/g/n wireless communication adapters, Bluetooth wireless adapters, and the like. Any known or later developed network adapters are intended to be within the spirit and scope of the present invention.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

1. A method, in a data processing system, for executing queries
referring data stored in a unified data layer, the method comprising:
receiving, by a relational engine executing on the data processing system, a structured query language (SQL) query from a client;
accessing, by a query processor executing on the data processing system, integrated data sources including a unified data layer (UDL) data source storing UDL topic files via a data virtualization layer to form query results, wherein the data virtualization layer projects the UDL topic files into relational form; and
returning, by the relational engine, the query results to the client.

2. The method of claim 1, wherein a mapping service maps schema from a schema registry to UDL topic files.

3. The method of claim 2, wherein the data virtualization layer projects the UDL topic tiles into relational form using the mapping of the schema to the UDL topic files.

4. The method of claim 1, wherein the data virtualization layer projects the UDL topic files into relational form based on a SQL execution plan.

5. The method of claim 1, wherein the integrated data sources further include a federated database management system data source.

6. The method of claim 1, wherein the query processor requests subsetted results from each UDL topic file.

7. The method of claim 1, wherein the query processor uses an index to determine if there are any UDL topic files that need not be included because they have no data of interest based on the SQL query.

8. The method of claim 1, wherein the client is an object-oriented database connectivity client or an Open Database Connectivity (ODBC) client.

9-20. (canceled)
